(19) United States
(12) Patent Application Publication
(10) Pub. No.: US 2012/0128865 A1
(43) Pub. Date: May 24, 2012

(54) APPARATUS FOR FORMING ELECTRODE AND METHOD FOR FORMING ELECTRODE USING THE SAME

(75) Inventors: Hyun Hee GU, Gyeonggi-do (KR); Young Geun KWON, Seoul (KR); Byung Jun JEON, Seoul (KR); Ji Sook KIM, Seoul (KR); Kyu Ha LEE, Gyeonggi-do (KR); Chang Hoon KIM, Gyeonggi-do (KR); Myung Jun PARK, Chungcheongbuk-do (KR)

(73) Assignee: SAMSUNG ELECTRO-MECHANICS CO., LTD.

(21) Appl. No.: 13/071,739

(22) Filed: Mar. 25, 2011

(30) Foreign Application Priority Data
Nov. 22, 2010 (KR) 10-2010-0116172

(51) Int. Cl. B05D 5/12; B05D 1/18; B05C 3/00

(52) U.S. Cl. 427/58; 118/400

(57) ABSTRACT

Disclosed herein is an apparatus for forming an electrode on a surface of a ceramic laminate. The apparatus for forming an electrode includes: a blast surface plate having ruggedness to which an electrode material paste is applied; and a moving device moving a ceramic laminate so that the ceramic laminate contacts the blast surface plate.

### CROSS REFERENCE(S) TO RELATED APPLICATIONS

This application claims the benefit under 35 U.S.C. Section [120, 119, 119(e)] of Korean Patent Application No. 10-2010-0116172, entitled “Apparatus For Forming Electrode And Method For Forming Electrode Using The Same” filed on Nov. 22, 2010, which is hereby incorporated by reference in its entirety into this application.

### BACKGROUND OF THE INVENTION

1. Technical Field

The present invention relates to an apparatus for forming an electrode and a method for forming an electrode using the same, and more particularly, to an apparatus for forming an electrode capable of forming an external electrode of a ceramic laminate at a uniform thickness and a method for forming an electrode using the same.

2. Description of the Related Art

Due to the rapid development of electronic products being compact and slim, a method of mounting components has been changed from insert mounting to surface mounting with remarkably improved work efficiency. According to the change in mounting technology, there is a demand for the development of a hexahedral small-sized chip component in which surface mounting of the electronic components can be performed and mounting density can be doubled. However, the existing insert mounting technology using lead could not meet the demand of the product.

Therefore, a laminate technology three-dimensionally stacking a dielectric material and configuring an electrode by a screen printing scheme has been commercialized and the technology leads to compactness of products at a higher rate.

Under the circumstances, the multilayer ceramic capacitor has been emerging as a representative passive component of which demand has recently increased sharply.

Generally, capacitors are passive components that serve to store charges according to an electrode area with respect to a thickness of a dielectric material by applying voltage. Among the capacitors, a multilayer ceramic capacitor, which is a chip-type capacitor multilayering the dielectric layer and the electrode area as compact thin layers according to usage of rated voltage and capacitance. The multilayer ceramic capacitor may be surface-mounted, thereby making it possible to implement high-efficiency and high-reliability mounting, and have small internal inductance, thereby making it possible to be used up to a high frequency band. As a result, the multilayer ceramic capacitor is mainly used in electronic equipment having a differential and integral circuit for a by-pass filter.

Generally, a multilayer ceramic capacitor, which is one kind of chip capacitor, may implement high capacitance by printing an electrode on a ceramic sheet and then stacking it to have an effect that several capacitors are connected in parallel, wherein the multilayer ceramic capacitor is configured of a ceramic laminate printed with an internal electrode and an external terminal electrically connecting the ceramic laminate.

In the case of an ultra-high capacitance and ultra-compact type multilayer ceramic capacitor, the thickness of the external electrode layer is reduced to make an overlap area with an internal electrode in the chip relatively large, while maintaining the same entire chip size, thereby making it possible to have a freedom in designing the capacitance, and the thickness of a chip cover or a margin is formed to be relatively thick, thereby making it possible to improve chip reliability.

As a method to apply an electrode to an external terminal, a dipping-blotting method is the most generally used, which dips the external terminal in an electrode material paste put in a surface plate.

A process of forming an external electrode may be appreciated with reference to FIG. 1. Referring to FIG. 1A, a dipping process is performed by applying an electrode material paste 30 onto a surface plate 20, injecting a ceramic laminate 10 formed with the external terminal into the electrode material 30, and then dipping the external terminal of the ceramic laminate 10 with the electrode material 30.

At this time, since the central portion A of the external terminal is thickly applied, the chip is injected again onto the surface plate 20 on which the electrode material paste 30 is few to be subjected to a blotting process that partially removes the electrode material 30 dipped in the central portion A, as shown in FIG. 1B.

In this case, the paste-phase electrode material 30 for an external terminal is a viscoelastic fluid in which Cu powder and a solid content of glass frit occupy 70 wt % or more over the entirety thereof, wherein a tail of the electrode material 30 is cut, while the electrode material 30 is gathered into one towards the central portion A in the blotting process as shown in FIG. 1B. At this time, as the electrode material 30 existing at the edge portion B of the external electrode is concentrated into the central portion, the edge portion B becomes thinner, such that a difference in the application thickness between the edge portion and the central portion becomes greater.

As described above, in the case of the ultra-high capacitance multilayer ceramic capacitor, necessity to make the application thickness of the external electrode thinner gradually increases. Due to this necessity, the edge portion of the external electrode becomes weaker to be disconnected or causes the deteriorated electrode connectivity and the density of the electrode itself also becomes degraded.

In other words, in the dipping method, it is difficult to reduce the thickness of the external terminal electrode layer to be 10 μm or less. Although the electrode thickness is reduced through improvement in a paste material or an application process (A→B) as shown in FIG. 2, the edge portion is not sufficiently applied therewith and the density of the electrode is degraded.

Therefore, a need exists for a new method for forming an external electrode which improves electrode density and uniformly distributes the external electrode in the edge portion of the electrode, while implementing a thin layer electrode having an external terminal electrode layer whose thickness is 10 μm or less.

### SUMMARY OF THE INVENTION

An object of the present invention is to provide an apparatus for forming an electrode and a method for forming an electrode using the same.

According to an exemplary embodiment of the present invention, there is provided an apparatus for forming an electrode, including: a blast surface plate having ruggedness to which an electrode material paste is applied; and a moving device moving a ceramic laminate so that the ceramic laminate contacts the blast surface plate.

In the ruggedness of the blast surface plate, a difference between mountain and valley may be 100 nm to 5 mm and a distance between mountains may be 100 nm to 5 mm.

According to an exemplary embodiment of the present invention, there is provided a method for forming an electrode on a ceramic laminate using an apparatus for forming an electrode including a blast surface plate having ruggedness and a moving device moving the ceramic laminate so that the ceramic laminate contacts an electrode material paste on the blast surface plate, including: applying the electrode material paste to the blast surface plate; dipping the ceramic laminate in the electrode material paste applied onto the blast surface plate; and uniformly distributing the electrode material paste on the surface of the ceramic laminate by blotting the ceramic laminate on the surface plate.

In the ruggedness of the blast surface plate, a difference between mountain and valley may be 100 nm to 5 mm and a distance between mountains may be 100 nm to 5 mm.

The ruggedness of the blast surface plate may be formed by physical impact, mechanical processing, and chemical etching.

### BRIEF DESCRIPTION OF THE DRAWINGS

FIG. 1 is a diagram exemplifying a dipping-blotting process, as a method of forming an external terminal electrode according to the related art;

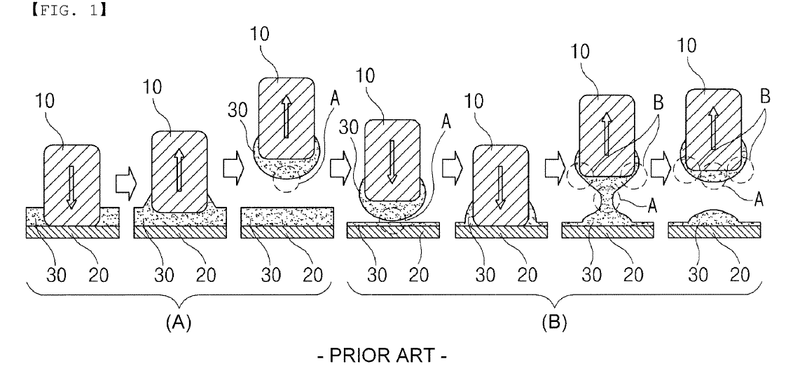

FIG. 2 is a cross-sectional view capable of confirming deterioration in applicability at edge portions and electrode connectivity according to reduction in an external electrode application thickness, in the case of forming the external terminal electrode according to the related art;

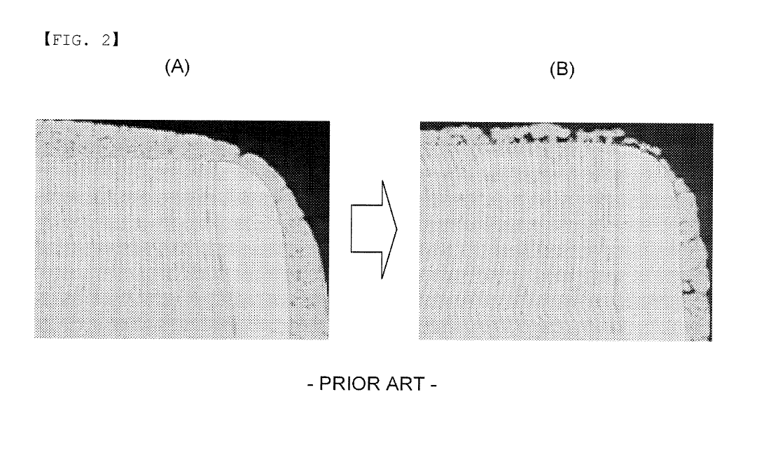

FIG. 3 is a diagram for explaining a method of forming an electrode using an apparatus for forming an electrode according to the present invention;

FIG. 4 shows surface roughness of a blast surface plate used in the exemplary embodiment of the present invention;

FIG. 5 is a graph comparing evenness in external terminal electrode application thicknesses according to a difference between a general surface plate (Comparative Example) and a blast surface plate (Example of the present invention); and

FIG. 6 is a graph comparing densities and evenness in external terminal electrode application thicknesses according to a difference between a general surface plate (Comparative Example) and a blast surface plate (Example of the present invention).

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a method for forming an electrode according to an exemplary embodiment of the present invention will be described in detail with reference to the accompanying drawings.

In order to manufacture a ceramic laminate 10 printed with an internal electrode according to the present invention, an internal electrode may first be printed on a dielectric sheet.

The dielectric sheet, which is a layer in which charges are stored in a capacitor, may be prepared by preparing dielectric ceramic powders composed of temperature compensating materials of a paraelectric generally having TiO₂ as a main component depending on change in temperature and a ferroelectric having BaTiO₃ or the like in a slurry form and then allowing the prepared slurry to be subjected to a doctor blade method.

The internal electrode, which is to inject charges by applying voltage to a dielectric sheet that serves as a charge storage, may be formed by a silk screen printing on the dielectric sheet fabricated by the doctor blade method.

Then, the dielectric sheet whose surface is printed with the internal electrode is stacked in a zigzag form. The stack may be generally made by a pressure lamination method. The number of stacks is generally determined according to the capacitance of a capacitor to be designed; however, 30 to 100 layers of dielectric sheets may be generally stacked.

Then, the stacked dielectric sheet may be dried and fired so that both a binder and an organic solvent used in forming a slurry in the dielectric sheets may be volatilized to be dried.

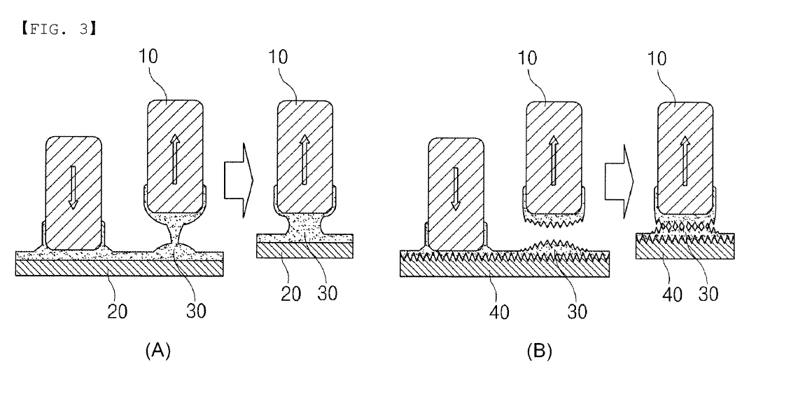

The state in which the dielectric sheets whose surface is printed with the internal electrode are stacked in a zigzag form and are subjected to drying and firing to be completely dried is defined as a laminate 10, which is shown in FIG. 3.

Then, an external electrode, that is, an electrode electrically connecting the internal electrode to the outside, is formed on the laminate 10, and a dipping method and a transferring method by a wheel are commonly used as a method for forming an external electrode. In the present invention, the external electrode may be formed by a dipping method.

FIG. 3 is a diagram for explaining a method of forming an electrode using an apparatus for forming an electrode according to the present invention. More specifically, FIG. 3A is a diagram showing a blotting process using an apparatus for forming an electrode according to the related art, and FIG. 3B is a diagram showing a blotting process using an apparatus for forming an electrode according to the present invention.

As shown in FIG. 3B, in the dipping method of the present invention, the blotting process may be progressed using a blast surface plate 40 and a moving device (not shown) vertically moving the ceramic laminate 10 on the blast surface plate 40.

The blast surface plate 40 may have a surface on which roughness is provided by strongly colliding fine solid phase particles or liquid phase particles with the metal surface thereof or using mechanical processing or chemical etching, thereby making it possible to have a structure in which ruggedness is formed on the surface thereof. As the moving device, various kinds of moving units may be used. The moving device may move the ceramic laminate 10 so that the ceramic laminate 10 is in contact or not in contact with an electrode material paste 30 applied on the ruggedness of the blast surface plate 40.

When the blast surface plate 40 is used, the electrode material paste 30 may have several tails due to the ruggedness. In this case, it is possible to prevent the edge portions of the electrode material paste 30 applied to the external electrode edge of the ceramic laminate 10 from being pushed to the central portion to be thin.

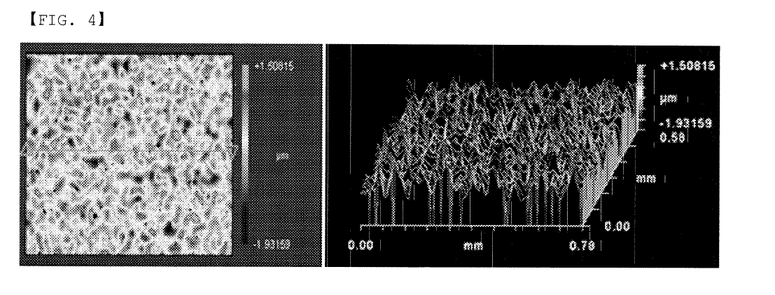

FIG. 4 shows surface roughness of a blast surface plate 40 used in the exemplary embodiment of the present invention. Referring to FIG. 4, in the ruggedness of the blast surface plate 40, a difference between a mountain and a valley may be 100 nm to 5 mm and a distance between mountains may be 100 nm to 5 mm for uniform application of the electrode material paste 30. Herein, the difference between the mountain and the valley and the distance between the mountains have an influence on the surface roughness of the blast surface plate, wherein the distance between the mountains may also be interpreted as a distance between valleys. That is, the ruggedness may include those irregular but those substantially regular is preferable.

After the application to the external electrode is completed, it is dried and fired at about 100 to 200° C., thereby making it possible to complete a multilayer ceramic capacitor.

### Example

A conductive paste composition for an external electrode including 75 wt % of Cu as a conductive metal powder, 5 wt % of glass frit, 7 wt % of polybutylmethacryalate as a binder resin, and a solvent was prepared and was blotted on a blast surface plate where a difference between the mountain and the valley is 1 mm and a distance between the mountains is 500 nm, thereby forming an external electrode on a ceramic laminate.

### Comparative Example

An external electrode was formed on a ceramic laminate under the same condition as that in the Example, except that a granite surface plate of which a surface was not formed with ruggedness was used.

Results

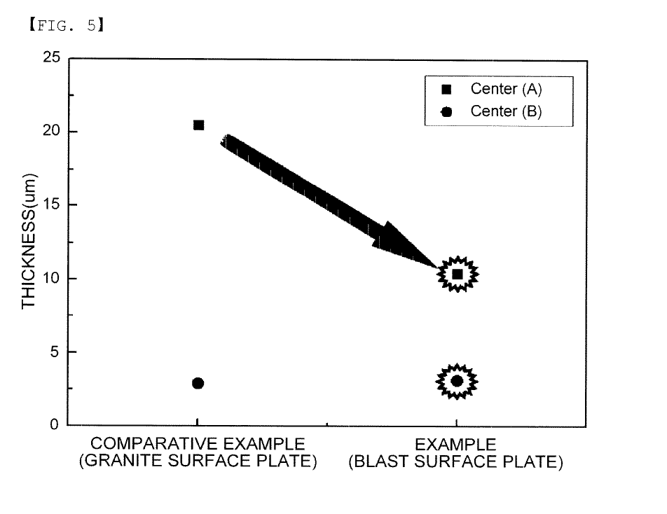

FIG. 5 is a graph comparing evenness in external terminal electrode application thicknesses according to a difference between a general surface plate (Comparative Example) and a blast surface plate (Example of the present invention). Referring to FIG. 5, when a general granite surface plate was applied with an electrode material paste to be blotted, there was a great difference in thickness between a central portion A and an edge portion B, whereas when a blast surface plate according to an exemplary embodiment of the present invention was used, a thickness of the edge portion B was hardly changed, while remarkably reducing a thickness of the central portion A, such that it could be appreciated that there was little difference between the central portion A and the edge portion B.

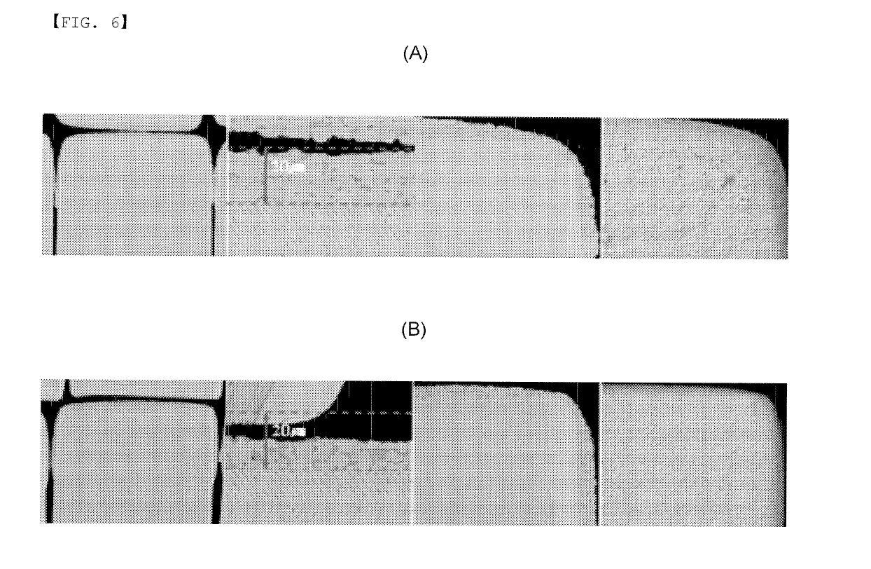

FIG. 6 is a graph comparing densities and evenness in external terminal electrode application thicknesses according to a difference between a general surface plate (Comparative Example) and a blast surface plate (Example of the present invention). Referring to FIG. 6, it can be appreciated that when a general granite surface plate is used, there is a great difference in thickness between a central portion (A) (almost 20 μm) and an edge portion, whereas when a blast surface plate according to an exemplary embodiment of the present invention is used, there is little difference in thickness between a central portion (B) (thinner than 20 μm) and an edge portion.

In other words, it can be appreciated from the experimental examples that according to the method for forming an electrode of the present invention, the application thickness at the edge portion of the electrode is sufficiently secured so that the electrode material is uniformly distributed on the external terminal, and as a result, the complete multilayer ceramic capacitor may secure excellent electrode connectivity and reliability.

According to the present invention, the apparatus for forming an electrode may form an electrode on a surface of a ceramic laminate at a uniform thickness, thereby making it possible to improve electrode connectivity and reliability of the multilayer ceramic capacitor.

According to the present invention, the method for forming an electrode may uniformly distribute the electrode material on the external terminal by securing a sufficient application thickness at the edge portion of the electrode, thereby making it possible to manufacture the multilayer ceramic capacitor with excellent electrode connectivity and improved reliability.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An apparatus for forming an electrode on an external surface of a ceramic laminate, printed with an internal electrode, comprising:
a blast surface plate having ruggedness to which an electrode material paste is applied; and
a moving device moving the ceramic laminate so that the ceramic laminate contacts the blast surface plate.

2. The apparatus for forming an electrode according to claim 1, wherein in the ruggedness of the blast surface plate, a difference between mountain and valley is 100 nm to 5 mm and a distance between mountains is 100 nm to 5 mm.

3. A method for forming an electrode on a ceramic laminate using an apparatus for forming an electrode including a blast surface plate having ruggedness and a moving device moving the ceramic laminate so that the ceramic laminate contacts an electrode material paste on the blast surface plate, the method comprising:
applying the electrode material paste to the blast surface plate;
dipping the ceramic laminate in the electrode material paste applied to the blast surface plate; and
uniformly distributing the electrode material paste on the surface of the ceramic laminate by blotting the ceramic laminate on the surface plate.

4. The method forming an electrode according to claim 3, wherein in the ruggedness of the blast surface plate, a difference between mountain and valley is 100 nm to 5 mm and a distance between mountains is 100 nm to 5 mm.

5. The method for forming an electrode according to claim 3, wherein the ruggedness of the blast surface plate is formed by physical impact, mechanical processing, and chemical etching.
